(19) United States
(12) Patent Application Publication
(10) Pub. No.: US 2022/0299231 A1
(43) Pub. Date: Sep. 22, 2022

(54) USE OF NEAR-FIELD COMMUNICATIONS FOR HVAC EQUIPMENT CONFIGURATION

(71) Applicant: Carrier Corporation, Palm Beach Gardens, FL (US)

(72) Inventors: Benjamen Baker, New Haven, IN (US); Jonathan Ferrara, South Whitley, IN (US); Paul Kiningham, Roanoke, IN (US); Adam Brouwer, Fort Wayne, IN (US)

(21) Appl. No.: 17/698,274

(22) Filed: Mar. 18, 2022

Related U.S. Application Data
(60) Provisional application No. 63/163,516, filed on Mar. 19, 2021.

(51) Int. Cl. F24F 11/63

(52) U.S. Cl. CPC F24F 11/63; H04B 5/0025

(57) ABSTRACT

A method and system for configuring a controller of a heating, ventilation, and air-conditioning (HVAC) equipment. The method can include receiving, with a near-field communication (NFC) module of the controller, configuration information for the HVAC equipment from a user device (e.g., equipped with near-field communications (NFC)), wherein the configuration information is used to configure the controller to control the HVAC equipment. The method can also include controlling the HVAC equipment based at least in part on the configuration information.

This application claims the benefit of U.S. Provisional Application No. 63/163,516 filed Mar. 19, 2021, the disclosure of which is incorporated herein by reference in its entirety.

### BACKGROUND

The present disclosure relates to hardware configuration, and more specifically, to configuring a controller of an HVAC equipment using a near-field communication device.

In today's environment, HVAC equipment is commonly operated using a controller. The controllers can be programmed (or “configured”) to provide control commands according to the type of equipment that is associated with the controller. Traditionally, HVAC equipment controllers are configured using a separate hardware known as a “model plug” that specifies to the controller a model number between 0 and 255, which enables the controller to use the correct model specific algorithm and unit operation constants for the HVAC equipment. This traditional configuring of the controller is a manual process performed by a service technician inserting the model plug into the controller (which is commonly a PCB board). In addition, the function of the model plug is somewhat limited. For example, the traditional model plug does not enable the retrieval of operational history, diagnostic information, etc. from the HVAC equipment. Accordingly, there remains a need for an improved way to configure HVAC equipment controllers.

### BRIEF DESCRIPTION

According to an embodiment, a method for configuring a controller of a heating, ventilation, and air-conditioning (HVAC) equipment is provided. The method can include receiving, with a near-field communication (NFC) module of the controller, configuration information for the HVAC equipment from a near-field communications user device, and configuring the controller using the configuration information from the user device. The method can also include controlling, using the controller, the HVAC equipment based at least in part on the configuration information

In addition to one or more of the features described herein, or as an alternative, further embodiments include storing the received configuration information when power is not supplied to the controller.

In addition to one or more of the features described herein, or as an alternative, further embodiments include transferring the configuration information to a memory of the controller responsive to supplying power to the controller.

In addition to one or more of the features described herein, or as an alternative, further embodiments include transmitting, from the NFC module of the controller, operational information of the HVAC equipment to the user device, wherein the operational information includes at least one of fault information, runtime information, or history information.

In addition to one or more of the features described herein, or as an alternative, further embodiments include receiving at the NFC module a command from the user device to control the HVAC equipment.

According to an embodiment, a method for configuring a controller of an HVAC equipment is provided. The method can include storing configuration information, in a user device, wherein the configuration information is used to configure the controller, wherein the configuration information of the controller is used to control HVAC equipment, and transmitting the configuration information from the user device to a near-field communication (NFC) module of the controller.

In addition to one or more of the features described herein, or as an alternative, further embodiments include receiving, at the user device, operational information of the HVAC equipment from the NFC module of the controller.

In addition to one or more of the features described herein, or as an alternative, further embodiments include using operational information that is at least one of fault information, runtime information, or history information.

In addition to one or more of the features described herein, or as an alternative, further embodiments include using configuration information that includes at least one of a serial number, a model number, a recipe or software information that is used to configure the controller.

In addition to one or more of the features described herein, or as an alternative, further embodiments include transmitting configuration information to the controller using an NFC standard.

According to a different embodiment, a controller of a heating, ventilation, and air-conditioning (HVAC) equipment is provided. The controller can include a near-field communication (NFC) module and a memory, wherein the NFC module comprises a non-volatile memory (NVM), the NFC module is configured to receive configuration information for the HVAC equipment from a user device, wherein the configuration information is used to configure the controller to control the HVAC equipment.

In addition to one or more of the features described herein, or as an alternative, further embodiments include the controller being further configured to receive configuration information from a model info device that is configured to be inserted into the controller.

In addition to one or more of the features described herein, or as an alternative, further embodiments include using configuration information that includes at least one of a serial number, a model number, a model type, a recipe, or a software information.

In addition to one or more of the features described herein, or as an alternative, further embodiments include wireless transmitting configuration information from the user device using an NFC standard.

In addition to one or more of the features described herein, or as an alternative, further embodiments include an NFC module that is configured to transmit operational history of the HVAC equipment to the user device.

In addition to one or more of the features described herein, or as an alternative, further embodiments include a non-volatile memory (NVM) of the controller that is configured to store the configuration information when power is not supplied to the controller.

Technical effects of embodiments of the present disclosure include enabling configuration between a controller of an HVAC equipment and a user device.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1 depicts an architecture of a system including a controller of a heating, ventilation, and air-conditioning (HVAC) equipment, a user device, and a model info device in accordance with one or more embodiments;

FIG. 2 depicts a flowchart of a method for configuring a controller for HVAC equipment in accordance with one or more embodiments; and

FIG. 3 depicts a flowchart of a method for providing the configuration information to a controller for HVAC equipment in accordance with one or more embodiments.

### DETAILED DESCRIPTION

A controller for a heating, ventilation, and air conditioning (HVAC) equipment can be configured (i.e., programmed) and reconfigured to operate different models and versions of equipment. For example, controllers may need to be reconfigured if the HVAC equipment is replaced or upgraded. Similarly, the controller may need to be configured upon initial installation (e.g., if the previously-installed controller is replaced). Existing techniques to configure the controller may require a service technician to set a plurality of dip-switches that are present on the control board of the controller. Therefore, in order to reconfigure such a controller, the control board must typically be manually accessed by the service technician and the dip-switches must be physically set to the correct position. If the dip-switches are incorrectly set, the service technician will have to reset the dip-switches again to properly configure the controller.

Conventional controllers include configuration tables that take up a substantial amount of memory. The configuration table can store many configurations that can be accessed by the controller to inform the controller how to operate the HVAC equipment (i.e., to which it is connected to). Some existing controllers may require additional hardware components to configure the controller (i.e., the configuration table). The hardware can include a model plug which is a hardware component that stores the model identifier for the piece of HVAC equipment that is controlled by the controller. The model plug is a “dumb” component that includes a resistor network that is fixed on a printed circuit board (PCB) to store the model information. The resistor network can include one or more resistors where the resistor value represents a model identifier for a piece of HVAC equipment. The model plug is inserted into the controller to allow the controller to read the model identifier represented by the resistor values of the resistor network from the model plug. Upon start-up, the model information is used to index into the configuration table that is stored on the control board to retrieve the configuration corresponding to the model identifier from the model plug. The configuration table can store large amounts of information and only selects one of the configurations that correspond to the model plug at a time. This can lead to inefficiently managed storage since the plurality of other configurations are not currently needed or used. The model identifier enables the controller to obtain, from the configuration table, the correct model-specific algorithm and operation constants for the equipment that is coupled to the controller. For example, the algorithms and control configuration for a 9-speed motor and a pulse-width modulation (PWM) motor can require different control logic for proper operation. When new equipment is introduced to the controller, the model plug corresponding to the equipment is commonly required to configure the controller. This requirement for an additional piece of hardware to configure the controller is inconvenient both for technicians and end consumers.

Additionally, in existing controllers, diagnostic information is provided to the service technician using a flashing light-emitting diode (LED) that is located on the housing of the controller. The flashing LED may use a few colors such as green, orange, and red to indicate a state of operation of the equipment. However, the limited information from the flashing LED does not provide a detailed operational history of the HVAC equipment. As such, currently, the operational history is not retrievable on non-communicating equipment.

The techniques of the one or more embodiments described herein enable an external device, such as a user device (equipped with near-field communication (NFC), to configure the controller for the paired piece of equipment and obtain system information such as operational data for the piece of equipment. This may remove the need for the controller to store all of the unused configurations in the configuration table, which may present an opportunity to use the unused memory to store other data in the controller. In some embodiments, the communication standard that is used between the controller and the user device is the near-field communications (NFC) standard. This can allow a user device that is within proximity to the controller to configure the controller with the selected configuration information (e.g., without having to manually interact with the controller, which is commonly in a difficult to reach location). For example, in some embodiments, the dip-switches may not be required to be manually set by the service technician, which may reduce the opportunity for error in the configuring or reconfiguring of the controller. In some embodiments, the model plug may not be required for configuring the controller because a user device can be used to configure the controller instead. However, it will be appreciated that the controller may retain the ability to be configured with a model plug (e.g., in addition to the ability to be configured with a user device).

Also, the techniques of one or more embodiments described herein may enable a service technician or operator to obtain the historical data of the equipment. For example, the operational data stored in the memory of the controller may transfer the data to a user device using the NFC module of the controller.

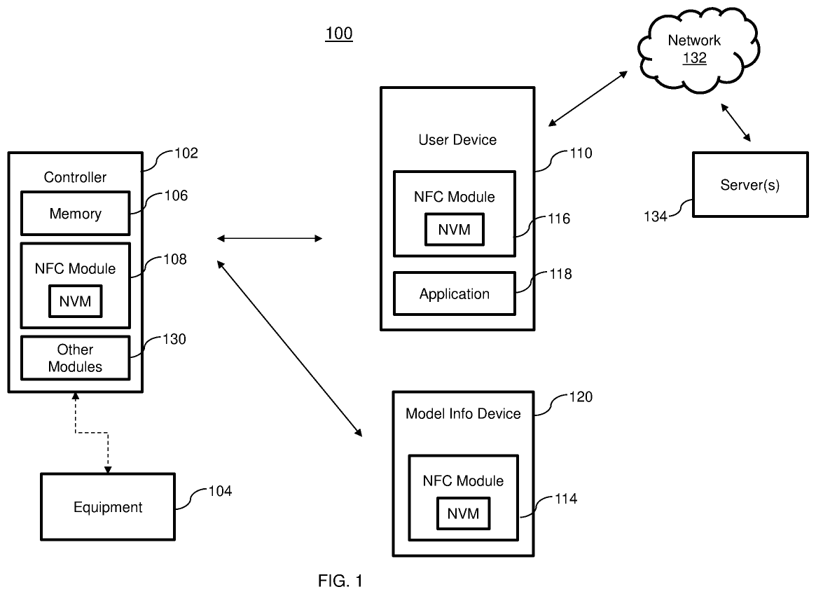

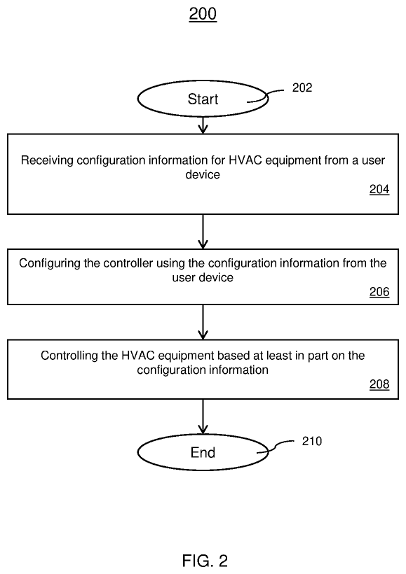

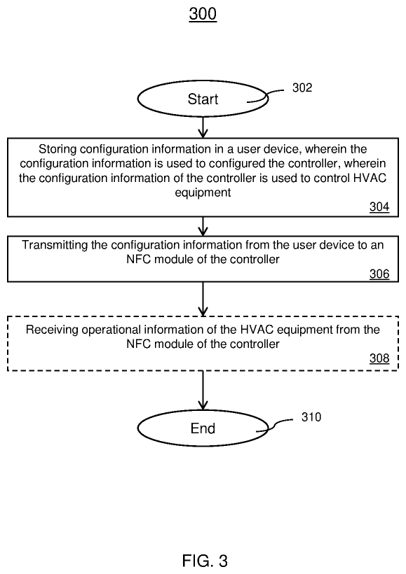

FIG. 1 depicts a block diagram of a system 100 including a controller 102 of an HVAC equipment 104 in accordance with one or more embodiments. In a non-limiting example, the controller is an HVAC furnace controller which is described with reference to FIG. 1, but it should be understood that different types of equipment can be used with the controller and FIG. 1 is not intended to limit the scope of the disclosure. The controller 102 can include a memory 106 and an NFC module 108 (or NFC tag) for communicating with other devices. In one or more embodiments, the NFC module 108 can include its respective memory (i.e., a non-volatile memory, NVM) and one or more communication interface(s) (not shown) to communicate with other modules and/or devices. For example, the communication interface can enable the controller 102 to communicate with other NFC modules of other devices. In a different example, the communication interface of the NFC module 108 can enable the controller 102 to communicate with other components on the controller 102 such as the memory 106 that is located on the control board. The NVM of the NFC module 108 can be configured at the manufacture prior to shipment to a customer. If the controller 102 is being replaced, the NVM of the NFC module 108 may be blank and may require configuration prior to use. The controller 102 can be configured using the model info device 120 or the user device 110 as discussed below with reference to FIGS. 2 and 3. The controller 102 can include additional modules 130 such as but not limited to sensors, timers, interfaces, etc. that can be used to track the operation and performance of the equipment 104. Such devices can include but are not limited to an model info device 120 (which may be similar to a traditional model plug with NVM) and a user device 110, where the user device 110 can include but is not limited to a smart phone, a tablet, or other computing device.

The model info device 120 can include an NVM module 114 (i.e., a non-volatile memory, hereinafter referred to as NVM). The NVM of the model info device 120 can store the configuration information for a piece of equipment that is to be coupled to the controller 102. The configuration information can include but is not limited to serial numbers, models numbers, equipment type information, model type, etc. For example, each model info device 120 may be programmed with recipes for a specific furnace and marked with a recipe number. In a non-limiting example, the configuration information for a furnace can include information related to cabinet sizes, types of burners, airflow values, times, etc. The model info device 120 may be configured to communicate with the controller 102 when it is inserted into the controller 102 (e.g., over a serial communications bus, such as an I2C serial communications bus) to configure the controller 102 with the configuration information from the NVM of the NVM module 114. It will be appreciated that other types of communicates busses may be used.

With reference to FIG. 1, the system 100 can include the user device 110 which includes a processor and a memory (not shown) that is configured with instructions for operating the user device 110. The user device 110 can also be equipped with an NFC module 116 to communicate with the controller 102. In one or more embodiments, the NFC module 116 can include its respective memory (i.e., a non-volatile memory, hereinafter referred to as NVM) and a one or more communication interface(s) (not shown) to communicate with other modules and/or devices. The user device 110 can also include an application 118 that is used to communicate with the controller 102. The user device 110 can be used to provide the initial configuration for a new controller 102 or to modify the configuration information for a current controller 102. In one or more embodiments, the application 118 of the user device 110 can be used to provide commands to operate the equipment 104. For example, the communication can also include modifying one or more parameters or settings stored in the controller 102 for operating the equipment 104 such as blower speed, motor operation, etc. In one or more embodiments, the user device 110 can obtain the configuration information from the equipment 104 over a network 132. The network 132 can include one or more servers 134 in a cloud network or other type of network that provides the configuration information.

The application 118 can provide an interface for a service technician to communicate with the controller 102. The NFC modules 108 and 116 allow the controller 102 and the user device 110 to communicate directly with each other without going through a network such as a Wi-Fi network. In a non-limiting embodiment, the proximity for communication between the controller 102 and the user device 110 can include a range up to 2 inches, up to 4 inches, or up to 6 inches. These ranges are only an example illustration and are not intended to limit the scope of the disclosure.

The interface for the application 118 can be updated as the functionality of the controller 102 and/or equipment 104 are developed. The application 118 can be configured to display the options that are available to the controller 102 and/or equipment 104. For example, options can be shown for a blower motor such as speed or duration of operation. If the HVAC equipment 104 does not have a blower motor, then options for a blower motor will not be displayed on the controller 102.

In one or more embodiments, the application 118 can obtain the system information from the controller 102. The system information can include but is not limited to active fault codes, fault code history, cycle information, hours in operation or downtime, time in-service, etc. In addition, the application 118 of the user device 110 can be used to transmit commands to the controller 102 to clear the fault history, clear cycle/hours, etc.

In one or more embodiments, the controller 102 can store the configuration information in the NVM of the NFC module 108 while the controller 102 is not powered on. The energy that is generated between an NFC transmission between the NFC modules 108 and 116 can be used to transfer the configuration information from the user device 110 to the controller 102 when the devices are within proximity to each other. The configuration information can be stored in the NVM and upon start-up, the controller 102 can retrieve the configuration information from the NVM of the NFC module 108 and transfer and store the configuration information in the memory 106. The memory 106 can then store the following information and is not limited to a serial number, a model number, recipe information, software information, etc. In the example where the HVAC equipment 104 is an HVAC furnace, the memory 106 can also store the furnace airflow information, furnace type information, operational history information (hours, faults, etc.). In addition, the memory 106 can store information such as installer airflow selections, blower off delays, equipment runtime, furnace orientation, etc.

However, if upon start-up the controller 102 obtains the model recipe from the model info device 120 and it is empty, the controller 102 will provide a fault. When the fault is detected, the model info device can be inserted into the controller 102 to configure the controller 102 for operation of the HVAC equipment 104. The recipe will be copied from NVM of the model info device 120 to the memory 106 of the controller 102 for future use by controller 102.

One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

FIG. 2 depicts a flowchart of a method 200 for configuring a controller 102 of an HVAC equipment 104 in accordance with one or more embodiments. The method 200 can be performed in a system 100 such as that shown in FIG. 1. It will be appreciated that systems having different architectures are envisioned to be within the scope of the disclosure. The method 200 begins at block 202 and proceeds to block 204 which provides for receiving, using the controller 102, configuration information for the HVAC equipment 104 from a model info device 120 or a user device 110. In some embodiments, the equipment information includes the configuration information for the piece of HVAC equipment 104 coupled to the controller 102. In addition, the configuration information can include model type information, serial information, etc.

Block 206 configures the controller 102 using the configuration information. In one or more embodiments, the configuration information is transferred to the controller 102 when the model info device 120 is inserted into the controller 102. In a different embodiment, the configuration information can be transferred to the controller 102 from a user device 110 over NFC.

Block 208 controls the HVAC equipment 104 based at least in part on the configuration information. In one or more embodiments, the controller 102 stores the configuration information in its memory 106. The method 200 ends at block 210, however, it should be understood that different steps or additional steps can be used in accordance with one or more embodiments and is not intended to limit the scope of the disclosure.

Now referring to FIG. 3, a flowchart of a method 300 for configuring a controller 102 of an HVAC equipment 104 in accordance with one or more embodiments is shown. The method 300 begins at block 302 and proceeds to block 304 which provides for storing configuration information in a user device 110. Block 306 transmits the configuration information from the user device 110 to an NFC module of the controller 102. In certain instances the controller 108 and the user device 110 and/or the model info device 120 may communicate bi-directionally. For example, the controller 108 may receive configuration information from the user device 110 and/or the model info device 120 and may transmit operational information of the HVAC equipment 104 from NFC module of the controller 102 to the user device 100 and/or the model info device 120. The method 300 ends at block 310. However, it should be understood that different steps or additional steps can be used in accordance with one or more embodiments and is not intended to limit the scope of the disclosure.

One or more illustrative embodiments of the disclosure are described herein with reference to methods 200 and 300. Such embodiments are merely illustrative of the scope of this disclosure and are not intended to be limiting in any way. Accordingly, variations, modifications, and equivalents of embodiments disclosed herein are also within the scope of this disclosure.

The technical effects and benefits include reducing the overall HVAC control system complexity. In addition, the technical effects and benefits include enabling the control system configuration versality including the ease of control for control commissioning and equipment servicing in the factory and in the field. The technical effects and benefits can include reducing the control firmware releases used in the controller.

The technical effects and benefits also include an improvement in the controller memory utilization because the memory used for the configuration table is no longer required. In some embodiments, the controller memory and the NFC device are configured to control a particular piece of equipment at the manufacturer before being used in operation. This obviates the need for the controller to be programmed in the field. In other embodiments, when a control board of a controller is replaced, the NFC device or user application device can be used to configure the controller to operate the equipment. Often times during replacement, the control board is not configured with the configuration for any equipment and requires configuration upon replacement.

The techniques for one or more embodiments described herein improve over the prior art by enabling the configuration information, not just a model identifier, for the equipment to be retrieved from a model plug or user device. Conventional model plugs simply store a resistor value that represents the model identifier of the equipment, where the resistor value is used to retrieve the appropriate configuration from the configuration table stored in the controller. Conventional model plugs are unable to store configuration information as the NFC model plug described herein.

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method for configuring a controller of a heating, ventilation, and air-conditioning (HVAC) equipment, the method comprising:
receiving, with a near-field communication (NFC) module of the controller, configuration information for the HVAC equipment from a user device;
configuring the controller using the configuration information from the user device; and
controlling, using the controller, the HVAC equipment based at least in part on the configuration information.

2. The method of claim 1, further comprising storing, at the controller, the received configuration information when power is not supplied to the controller.

3. The method of claim 2, further comprising transferring the configuration information to a memory of the controller responsive to supplying power to the controller.

4. The method of claim 1, wherein the configuration information includes at least one of a serial number, a model number, a model type, a recipe, and software information that is used to configure the controller.

5. The method of claim 1, further comprising transmitting, from the NFC module of the controller, operational information of the HVAC equipment to the user device, wherein the operational information includes at least one of fault information, runtime information, or history information.

6. The method of claim 1, receiving at the NFC module a command from the user device to control the HVAC equipment.

7. A method for configuring a controller of a heating, ventilation, and air-conditioning (HVAC) equipment, the method comprising:
storing configuration information in a user device, wherein the configuration information is used to configure the controller, wherein the configuration information of the controller is used to control HVAC equipment; and
transmitting the configuration information from the user device to a near-field communication (NFC) module of the controller.

8. The method of claim 7, further comprising receiving, at the user device, operational information of the HVAC equipment from the NFC module of the controller.

9. The method of claim 8, wherein the operational information is at least one of fault information, runtime information, or history information.

10. The method of claim 7, wherein the configuration information includes at least one of a serial number, a model number, a model type, a recipe, or software information that is used to configure the controller.

11. The method of claim 7, wherein the configuration information is transmitted to the controller using an NFC standard.

12. A controller of a heating, ventilation, and air-conditioning (HVAC) equipment, the controller comprising:
a near-field communication (NFC) module and a memory, wherein the NFC module comprises a non-volatile memory (NVM), the NFC module configured to receive configuration information for the HVAC equipment from a user device, wherein the configuration information is used to configure the controller to control the HVAC equipment.

13. The controller of claim 12, wherein the controller is further configured to receive configuration information from a model info device that is configured to be inserted into the controller.

14. The controller of claim 12, wherein the configuration information includes at least one of a serial number, a model number, a model type, a recipe, or a software information that is used to configure the controller.

15. The controller of claim 12, wherein the configuration information is transmitted wirelessly from the user device using an NFC standard.

16. The controller of claim 12, wherein the NFC module is configured to transmit operational history of the HVAC equipment to the user device.

17. The controller of claim 12, wherein the NVM of the controller is configured to store the configuration information when power is not supplied to the controller.
